(19) United States
(12) Patent Application Publication
(10) Pub. No.: US 2025/0081953 A1
(43) Pub. Date: Mar. 13, 2025

(54) VISIBLE FISH STRIKE INDICATOR WITH ACCELEROMETER

(71) Applicants: Aaron Myers, Bossier City, LA (US); Ashton Poole, Benton, LA (US); Frank Clark, Jefferon, TX (US)

(72) Inventors: Aaron Myers, Bossier City, LA (US); Ashton Poole, Benton, LA (US); Frank Clark, Jefferon, TX (US)

(21) Appl. No.: 18/955,977

(22) Filed: Nov. 22, 2024

Related U.S. Application Data
(63) Continuation-in-part of application No. 18/202,595, filed on Jun. 28, 2023, now Pat. No. 12,185,709.

(51) Int. Cl. A01K 93/02

(52) U.S. Cl. CPC A01K 93/02

(57) ABSTRACT

A visible fish strike indicator may include a buoyant main housing with a horizontal center axis and center of gravity beneath the horizontal center axis allowing the indicator to float upright on water. A light-transmissible housing can be detachably supported by the main housing, with an indicator illumination assembly that includes an accelerometer. The accelerometer senses the indicator's position and accelerative forces. A microprocessor interfaces with the accelerometer to analyze position data and generate command signals. These signals control a current-limiting resistor system, which regulates electrical currents to an RGB LED system. This light-transmissible housing emits different colors to signal indicator operation or a fish strike.

### RELATED APPLICATION

This application is a continuation-in-part of, and incorporates by reference, U.S. patent application Ser. No. 18/202,595 filed on Jun. 28, 2023.

### FIELD OF THE INVENTION

Illustrative embodiments of the disclosure generally relate to fishing accessories. More particularly, illustrative embodiments of the disclosure relate to visible fish strike indicators which are buoyant and are configured to support an immersed fishing lure in a water body and provide visual indication to a remote user when a fish has struck the lure.

### SUMMARY OF THE INVENTION

Illustrative embodiments of the disclosure are generally directed to visible fish strike indicators which are buoyant and are configured to support an immersed fishing lure in a water body and provide visual indication to a remote user when a fish has struck the lure. An illustrative embodiment of the visible fish strike indicators may include a buoyant main housing having a horizontal center axis and a center of gravity beneath the horizontal center axis, whereby the main housing is configured to normally float in an upright horizontal position on a water body. A light-transmissible light housing having a light housing interior may be detachably supported by the main housing. An indicator illumination assembly may be supported by the main housing. The indicator illumination assembly may include at least one tilt switch configured to sense a vertical positioning event in which the main housing deploys from the upright horizontal position to a vertical position. A power source may interface with the tilt switch. A strike indicator light may interface with the tilt switch and the power source. The strike indicator light may be configured to emit a strike light pattern in the light housing. The tilt switch may be configured to energize the strike indicator light to emit the strike light pattern upon sensing the vertical positioning event.

In another embodiment of the invention, the visual fish strike indicator operates through an arrangement of components designed to detect and visually indicate fish strikes. This indicator includes an indicator illumination assembly integrated with a power source, an accelerometer, a microprocessor, a current limiting resistor system, and an RGB LED system. The power source, such as a 3-volt battery pack using two AAA batteries, supplies the necessary electrical power for the entire illumination assembly.

The accelerometer is configured to measure movement acceleration forces experienced by the fish strike indicator. In operation, accelerometer senses the acceleration forces and generates position data indicating the precise position of the fish strike indicator. In some instances, the fish strike indicator position data may include x-axis, y-axis data or x-axis, y-axis, and z-axis data. The accelerometer transmits the position data to the microprocessor.

Upon receiving the position data from the accelerometer, the microprocessor executes a series of pre-stored instructions in a microprocessor memory to determine which command to send to the RGB LED system. Using an internal clock, the microprocessor ensures that the commands are processed with precise timing, enabling the RGB LED system to react promptly to fish strikes. The microprocessor sends the command to the current limiting resistor system. The current limiting resistor system modulates the current flow to each LED die in the RGB LED system according to the command received from the microprocessor.

The current limiting system may control the color emitted by the RGB LED system by varying the current delivered to each LED die (e.g., the red, the green die or the blue die. RGB LED system receives the current from the current limiting system emits a range of colors, including red, green, blue, yellow, aqua, purple, or white. As described more fully below, the user has the option to select one or more of the available colors the user desires to be emitted.

A user may turn on (e.g., “initialize”) the fish strike indicator by manual shaking motion. For example, the user may move the fish strike indicator along the fish strike indicator x-axis and y-axis in a back-and-forth or left-to-right motion, while keeping the fish strike indicator main housing stationary along the z-axis. The shaking motion triggers the accelerometer to detect the changes in fish strike indictor position as a shaking motion and generate fish strike indicator position data (e.g., “initialization data”). The accelerometer may provide the fish strike indicator position data to the microprocessor.

This coordinated system ensures that the fish strike indicator reliably signals fish strikes with a visible illumination that can be easily seen in various lighting conditions. The fish strike indicator according to the various embodiments of the invention enhances the fishing experience with visual cues of both minor and significant fish strikes.

An exemplary embodiment, the present invention may include:
a buoyant main housing having a horizontal center axis and a center of gravity beneath the horizontal center axis, whereby the main housing is configured to normally float in an upright horizontal position on a water body;
   a light-transmissible light housing having a light housing interior detachably supported by the main housing;
   an indicator illumination assembly supported by the main housing, the indicator illumination assembly including:
      a power source for proving electrical power to the indicator illumination assembly;
      an accelerometer interfacing with the power source and receiving the electrical power from the power source, the accelerometer for sensing specific directions and patterns of movement of the visual fish strike indicator, and generating fish strike indicator position data,
      a microprocessor interfacing with the accelerometer and the power source, the microprocessor for receiving the fish strike indicator position data and generating operation command data based on the specific directions and patterns of movement of the visual fish strike indicator,
      a current limiting resistor system interfacing with the microprocessor, the current limiting resistor system configured to receive the operation command data from the microprocessor and provide an electrical current;
      an RGB LED system interfacing with the current limiting resistor system, the RGB LED system for receiving the electrical current and emitting a visible light.

### BRIEF DESCRIPTION OF THE DRAWINGS

Illustrative embodiments of the disclosure will now be described, by way of example, with reference to the accompanying drawings, in which:

FIG. 1 is a perspective view of an illustrative embodiment of the visible fish strike indicators;

FIG. 2 is a side view of the illustrative visible fish strike indicator illustrated in FIG. 1;

FIG. 3 is an end view of the illustrative visible fish strike indicator;

FIG. 4 is a top view of the illustrative visible fish strike indicator;

FIG. 5 is a longitudinal sectional view, taken along section lines 5-5 in FIG. 4, of the illustrative visible fish strike indicator, with a light housing attached to a main housing of the indicator and a typical indicator illumination assembly in the light housing;

FIG. 6 is an exploded side view, partially in section, of the illustrative visible fish strike indicator, with the light housing removed from the main housing of the indicator to expose the indicator illumination assembly;

FIG. 7 is a longitudinal sectional view of a switch bead conduit, a horizontal tilt switch, and a vertical tilt switch of the indicator illumination assembly, with a position switch bead disposed in the switch bead conduit and alternately closing the horizontal tilt switch and the vertical tilt switch depending on the horizontal or vertical position, respectively, of the indicator;

FIG. 8 is a longitudinal sectional view of the switch bead conduit, the horizontal tilt switch, and the vertical tilt switch of the indicator illumination assembly, with the switch bead closing the horizontal tilt switch to illuminate a pre-strike indicator light of the assembly when the visible fish strike indicator is oriented in the horizontal position on the water body;

FIG. 9 is a longitudinal sectional view of the switch bead conduit, the horizontal tilt switch, and the vertical tilt switch of the indicator illumination assembly, with the switch bead closing the vertical tilt switch to illuminate a strike indicator light of the assembly to indicate that a fish is hooked on a fishing line when the visible fish strike indicator is oriented in the vertical position on the water body;

FIG. 10 is a longitudinal sectional view of the switch bead conduit, the horizontal tilt switch, and the vertical tilt switch of the indicator illumination assembly, with the switch bead continuing to close the vertical tilt switch for continued illumination of the strike indicator light of the assembly after the visible fish strike indicator has reoriented from the vertical position back to the horizontal position;

FIG. 11 is a functional block diagram of the indicator illumination assembly illustrated in FIG. 5, with the position switch bead (illustrated in phantom) closing the horizontal tilt switch in the horizontal position of the visible fish strike indicator;

FIG. 12 is a functional block diagram of the indicator illumination assembly illustrated in FIG. 5, with the position switch bead (illustrated in phantom) closing the vertical tilt switch in the vertical position of the visible fish strike indicator;

FIG. 13 is a functional block diagram of a typical indicator illumination assembly suitable for implementation of the visible fish strike indicator;

FIG. 14 is a side view of the illustrative visible fish strike indicator, floating in the horizontal position on a water body with a fishing line attached to the indicator and a fishing lure on the fishing line, more particularly illustrating a pre-strike light pattern emitted from the light housing of the indicator to indicate to a remote user that a fish has not struck the fishing line;

FIG. 15 is a side view of the floating visible fish strike indicator illustrated in FIG. 14 as a fish strikes the fishing lure on the fishing line and pulls the indicator from the horizontal position illustrated in FIG. 14 to a vertical position on the water body, more particularly illustrating a strike light pattern emitted from the light housing of the indicator to indicate that the fish has become hooked on the fishing line; and

FIG. 16 is a side view of the floating visible fish strike indicator illustrated in FIG. 14 after the indicator has re-oriented to the horizontal position on the water body, with continued emission of the strike light pattern from the light housing of the indicator to indicate the presence of the fish on the fishing line to the remote user.

FIG. 17 is a block diagram of an exemplary indicator illumination assembly including an accelerometer useful with the present invention.

FIG. 18 is a cross-section view of an exemplary visible fish strike indicator including the indicator illumination assembly having an accelerometer according to the present invention.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, “up”, “down”, “above”, “below” and derivatives thereof shall relate to the invention as oriented in the Figures. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Unless expressly or implicitly indicated otherwise, throughout the description and the appended claims, the terms “comprise”, “comprising”, “comprised of” and the like are to be construed in an inclusive sense as opposed to an exclusive or exhaustive sense, and are equivalent to the phrase, “including but not limited to”. Each embodiment disclosed herein can comprise, consist essentially of, or consist of its particular stated element, step, ingredient, or limitation. As used herein, the transition term “comprise”, “comprises”, “includes”, “including”, “has”, or “having” means “includes, but is not limited to, and allows for the inclusion of unspecified elements, steps, ingredients, or limitations, even in major amounts”. The transitional phrase “consisting of” excludes any element, step, ingredient, or limitation not specified. The transition phrase “consisting essentially of” shall limit the scope of the embodiment to the specified elements, steps, ingredients, or limitations and to those that do not materially affect the embodiment.

The present invention is described in terms of individual elements (e.g., power source, accelerometer, microprocessor, current liming resistors, LED dies) by way of example. However, it is understood that various elements in the invention may be combined into a single element or system of elements.

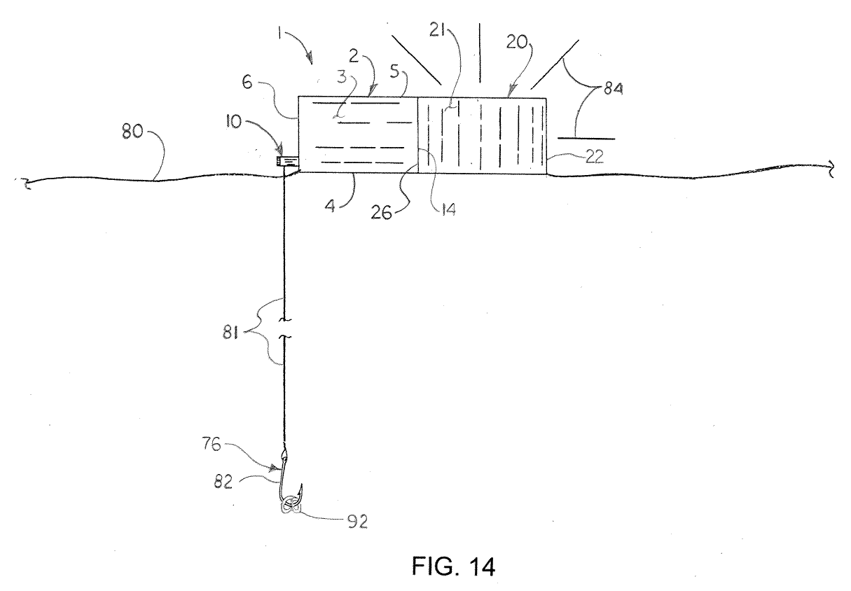

Referring to the drawings, an illustrative embodiment of the visible fish strike indicator, hereinafter indicator, is generally indicated by reference number 1. As illustrated in FIGS. 14-16, in typical application of the fish strike indicator 1, which will be hereinafter further described, a fishing line 81, to which is attached a fishing lure 76 such as an artificial fishing lure (not illustrated) or a fishing hook 82 with live bait 92 thereon, as illustrated in FIG. 14, may be attached to the fish strike indicator 1. The fish strike indicator 1 may be floated on the surface of a lake, pond, river, or other water body 80 in an upright horizontal position with the fishing lure 76 submerged beneath the surface of the water body 80.

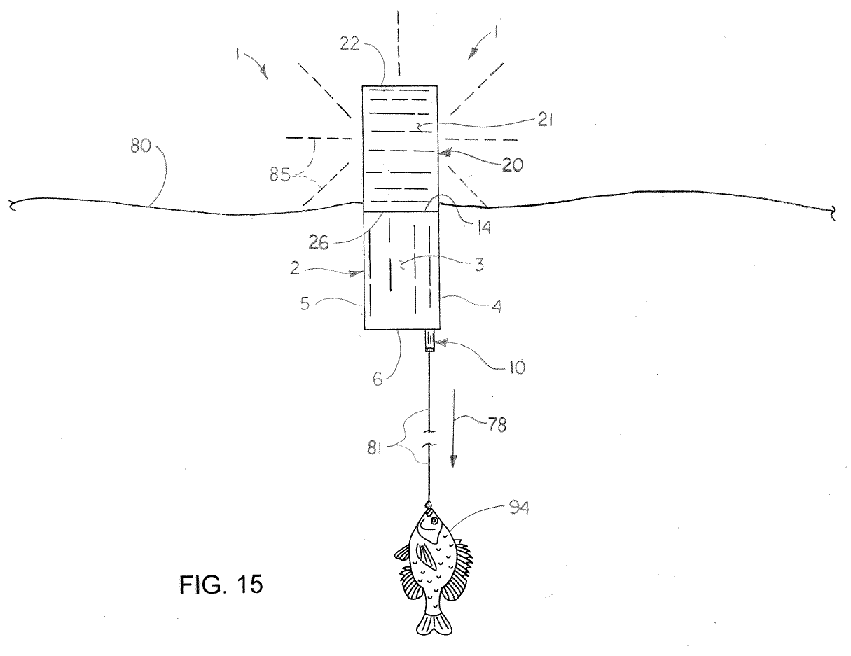

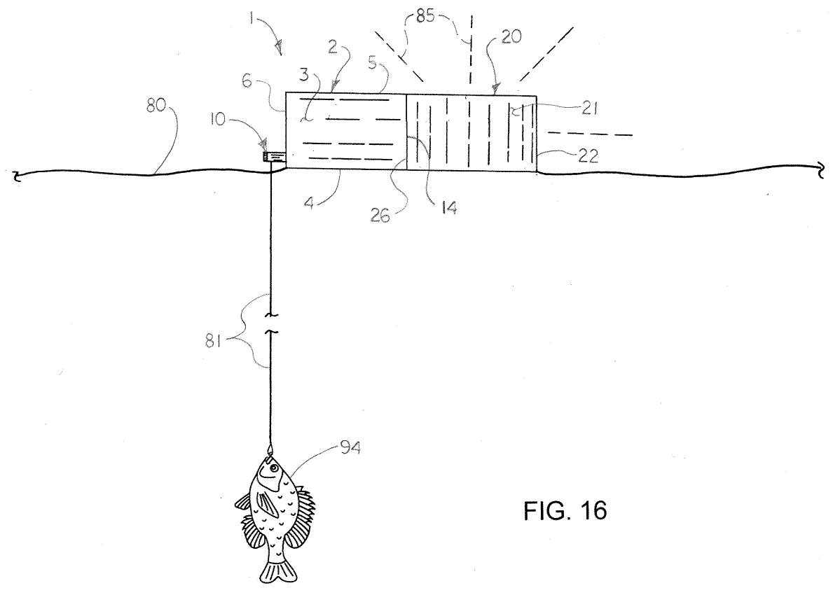

As illustrated in FIG. 14, the fish strike indicator 1 may be configured to emit a pre-strike light pattern 84 as it remains in the upright horizontal position on the water body 80. The pre-strike light pattern 84 may indicate to a remote user of the fish strike indicator 1 that a fish 94 (FIG. 15) has not become hooked on the fishing line 81, particularly at night or in a dark environment, typically as the user views the fish strike indicator 1 from the bank, a boat, or the like at a distance from the fish strike indicator 1. As illustrated in FIG. 15, as it subsequently strikes the fishing lure 76 and is hooked on the fishing line 81, the fish 94 may exert a downward force 78 on the fishing line 80. In the resulting vertical positioning event, the downward force 78 may re-orient the fish strike indicator 1 to an angled or vertical position, hereinafter vertical position, on the water body 80. The fish strike indicator 1 may be configured to responsively emit a strike light pattern 85, which differs from the pre-strike light pattern 84, responsive to the vertical positioning event. The fish strike indicator 1 may be configured to continue to emit the strike light pattern 85 after it subsequently returns to the upright horizontal position and as the fish 94 remains on the fishing line 81, as illustrated in FIG. 16. The strike light pattern 85 may indicate to the remote user that the fish 94 is hooked on the fishing line 81 such that the user can then approach and retrieve the fish strike indicator 1 for removal of the fish 94 from the fishing lure 76.

The pre-strike light pattern 84 and the strike light pattern 85 emitted by the fish strike indicator 1 may differ from each other by color, pattern, brightness, light combinations, and/or other visual characteristic(s). For example and without limitation, in some embodiments, the pre-strike light pattern 84 may be green, whereas the strike light pattern 85 may be blue. Additionally, or alternatively, the pre-strike light pattern 84 may be continuous whereas the strike light pattern 85 may be blinking or intermittent, or vice-versa.

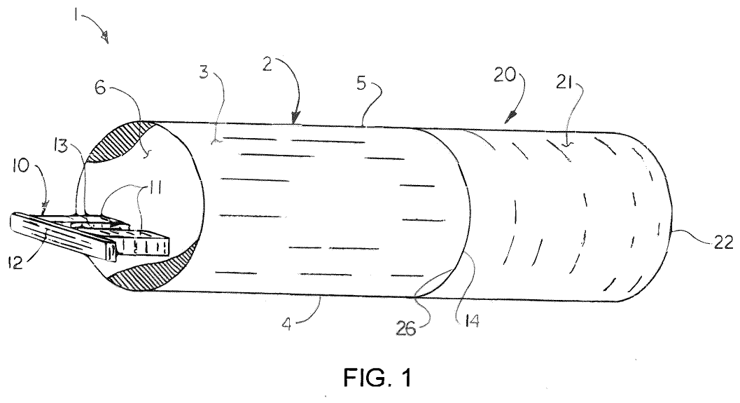

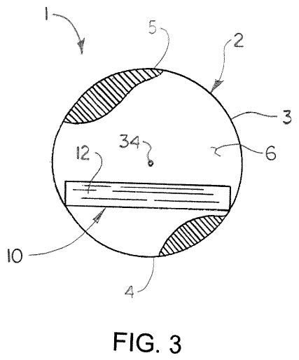

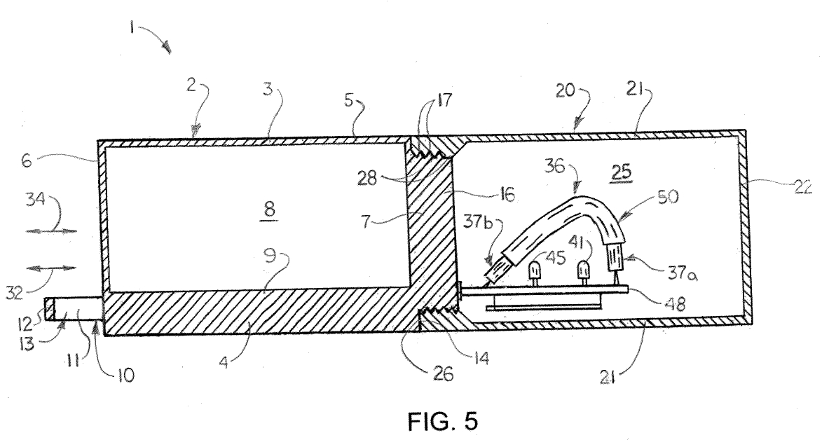

As illustrated in FIGS. 1-6, the indictor 1 may include a buoyant main housing 2. As illustrated in FIG. 5, the main housing 2 may have a horizontal center axis 34. In the upright horizontal position of the fish strike indicator 1 on the water body 80, as illustrated in FIG. 14, the center of gravity 32 of the main housing 2 may be disposed beneath the horizontal center axis 34 of the main housing 2. Accordingly, the low center of gravity 32 of the main housing 2 may configure the main housing 2 and the fish strike indicator 1 to normally float horizontally on the water body 80 in an upright position by preventing rotation of the main housing 2 about the horizontal center axis 34.

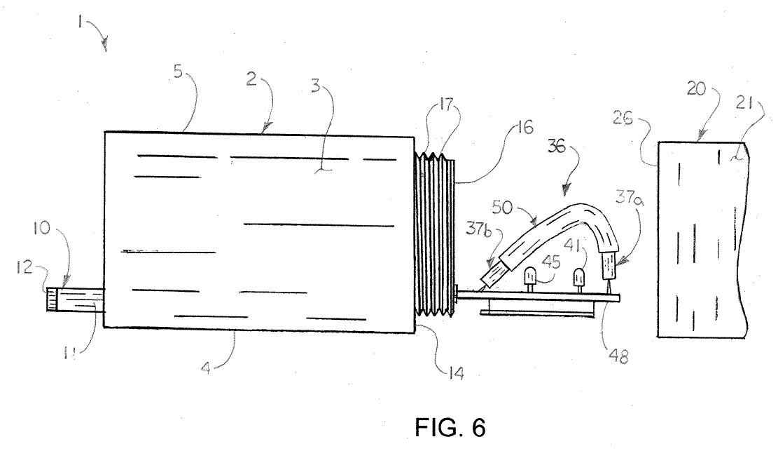

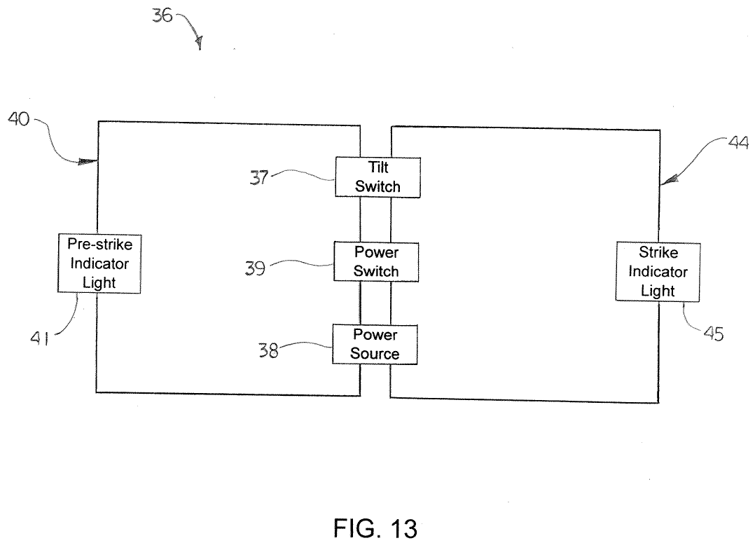

As illustrated in FIGS. 5 and 6, an indicator illumination assembly 36 may be supported by the main housing 2. As illustrated in FIG. 13, the indicator illumination assembly 36 may include at least one tilt switch 37, hereinafter tilt switch 37. The tilt switch 37 of the indicator illumination assembly 36 may be configured to sense the horizontal and vertical positions of the fish strike indicator 1 as well as the vertical positioning event in which the fish strike indicator 1 deploys from the upright horizontal position (FIG. 14) to the vertical position (FIG. 15).

A horizontal position circuit 40, having a pre-strike indicator light 41, and a vertical position circuit 44, having a strike indicator light 45, may electrically interface with the tilt switch 37 of the indicator illumination assembly 36. The horizontal position circuit 40 and the vertical position circuit 44 may include at least one power source 38. The tilt switch 37 may be configured to close the horizontal position circuit 40 and energize the pre-strike indicator light 41 to emit the pre-strike light pattern 84 as the fish strike indicator 1 remains in the upright horizontal position in the absence of the vertical positioning event, as illustrated in FIG. 14. The tilt switch 37 may be configured to open the horizontal position circuit 40 and close the vertical position circuit 44 to energize the strike indicator light 45 responsive to the vertical positioning event in which the fish 94 strikes the fishing line 81 and reorients the fish strike indicator 1 from the upright horizontal position to the vertical position, as illustrated in FIG. 15. The tilt switch 37 may be configured to maintain the closed position of the vertical position circuit 44 and continue to energize the strike indicator light 45 upon return of the fish strike indicator 1 from the vertical position back to the upright horizontal position as the fish 94 remains on the fishing line 81, as illustrated in FIG. 16.

The power source 38 may include any source which is capable of storing and supplying electrical current to the tilt switch 37, the pre-strike indicator light 41, and the strike indicator light 45. For example and without limitation, in some embodiments, the power source 38 may include at least one rechargeable and/or disposable battery.

In some embodiments, the horizontal position circuit 40 and the vertical position circuit 44 may include at least one power switch 39. The power switch 39 may facilitate selective manual actuation of the horizontal position circuit 40 and the vertical position circuit 44. The power switch 39 may have an “OFF” position and an “ON” position to de-energize and energize, respectively, the horizontal position circuit 40 and the vertical position circuit 44.

In some embodiments, a transparent or translucent light housing 20, having a light housing interior 25, as illustrated in FIG. 5, may extend from the main housing 2. The indicator illumination assembly 36 may be disposed in the light housing interior 25 of the light housing 20. Accordingly, the pre-strike indicator light 41 may be configured to emit the pre-strike light pattern 84, and the strike indicator light 45 may be configured to emit the strike light pattern 85, from the light housing 20.

As illustrated in FIGS. 1-6, in some embodiments, the main housing 2 of the fish strike indicator 1 may have a main housing sidewall 3. As illustrated in FIG. 5, the main housing sidewall 3 of the main housing 2 may include a lower main housing sidewall portion 4, an upper main housing sidewall portion 5, an exterior main housing end wall 6, an interior main housing end wall 7, and a main housing interior 8. As illustrated in FIG. 14, the lower main sidewall housing 4 of the main housing sidewall 3 may be configured to rest on the surface of the water body 80 as the fish strike indicator 1 floats on the water body 80. As further illustrated in FIG. 5, the exterior main housing end wall 6 and the interior main housing end wall 7 may close opposite ends of the main housing interior 8 at respective ends of the main housing sidewall 3.

A ballast portion 9 may be provided at the lower main housing sidewall portion 4 of the main housing sidewall 3. The ballast portion 9 may impart a higher weight to the lower main housing sidewall portion 4 than to the upper main housing sidewall portion 5. Accordingly, the ballast portion 9 may facilitate the lower center of gravity 32 relative to the horizontal center axis 34 of the main housing 2. The ballast portion 9 may include any structure, element, component, particulate composition, solid composition, or any combination thereof which impart(s) the additional weight to the lower main housing sidewall portion 4 relative to the upper main housing sidewall portion 5 of the main housing sidewall 3. For example and without limitation, in some embodiments, the ballast portion 9 may include a thickening of the lower main housing sidewall portion 4 relative to the upper main housing sidewall portion 5.

In some embodiments, at least one line attachment cleat 10 may extend from the main housing 2 to facilitate attachment of the fishing line 81 (FIGS. 14-16) to the fish strike indicator 1. For example, and without limitation, in some embodiments, the line attachment cleat 10 may extend from the exterior main housing sidewall 6 of the main housing 2. As illustrated in FIG. 5, in some embodiments, the line attachment cleat 10 may be disposed beneath the horizontal center axis 34 of the main housing 2.

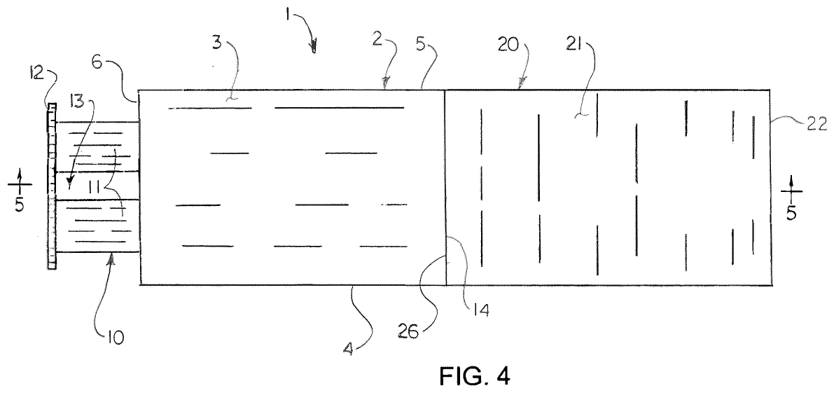

Line attachment cleat 10 may have any design or construction which facilitates secure attachment of the fishing line 81 to the fish strike indicator 1. The line attachment cleat 10 may additionally facilitate winding of the fishing line 81 thereon for transportation and/or storage purposes. Accordingly, as illustrated in FIG. 4, in some embodiments, the line attachment cleat 10 may include at least one, and typically, a pair of parallel, spaced-apart cleat arms 11 which extend from the main housing 2 of the fish strike indicator 1. A cleat head 12 may terminate the extending ends of the cleat arms 11. In some embodiments, a cleat slot 13 may extend between the cleat arms 11. In typical attachment of the fishing line 81 to the line attachment cleat 10, one end of the fishing line 81 may be securely tied to one of the cleat arms 11. The fishing line 81 may be wound around the cleat arms 11 and the fishing lure 76 tied to the opposite, free end of the fishing line 81. The main housing 2 and the line attachment cleat 10 of the fish strike indicator 1 may be fabricated of plastic, composite materials, fiberglass, closed cell extruded polystyrene foam (STYROFOAM™), polyethylene foam, and/or other suitable materials.

The light housing 20 may have any design which is suitable to facilitate emission of the pre-strike light pattern 84 and the strike light pattern 85 from the fish strike indicator 1. Accordingly, as illustrated in FIG. 5, in some embodiments, the light housing 20 may have a light housing sidewall 21, a light housing end wall 22, and the light housing interior 25. The light housing sidewall 21 and the light housing end wall 22 may be transparent, translucent, or otherwise light transmissible. The light housing sidewall 21 may have a light housing shoulder 26 which is opposite the light housing end wall 22. In some embodiments, the light housing sidewall 21 may be configured for detachable attachment to the main housing 2, typically as will be hereinafter described. The light housing 20 of the fish strike indicator 1 may be fabricated of plastic, composite materials, fiberglass, closed cell extruded polystyrene foam (STYROFOAM™), polyethylene foam, and/or other suitable materials.

In some embodiments, light housing 20 may be detachably attachable to the main housing 2 of the fish strike indicator 1 using any method or technique which is suitable for the purpose. For example and without limitation, as further illustrated in FIG. 5, in some embodiments, the main housing sidewall 3 of the main housing 2 may have a recessed housing shoulder 14. A housing nipple 16 may protrude from the housing shoulder 14. The housing nipple 16 may have external nipple threads 17. Housing shoulder threads 28 may recede from the light housing shoulder 26 on the interior surface of the light housing sidewall 21 of the light housing 20. The shoulder threads 28 of the light housing 20 may be configured for rotatable engagement with the companion nipple threads 17 on the housing nipple 16 of the main housing 2 to facilitate detachable and fluid-sealing attachment of the light housing 20 to the main housing 2 as the light housing shoulder 26 engages the housing shoulder 14 on the main housing 2.

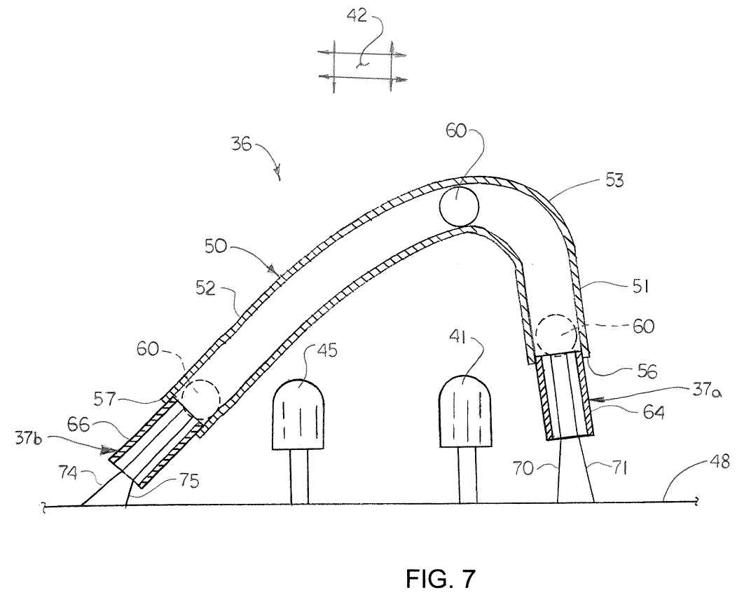

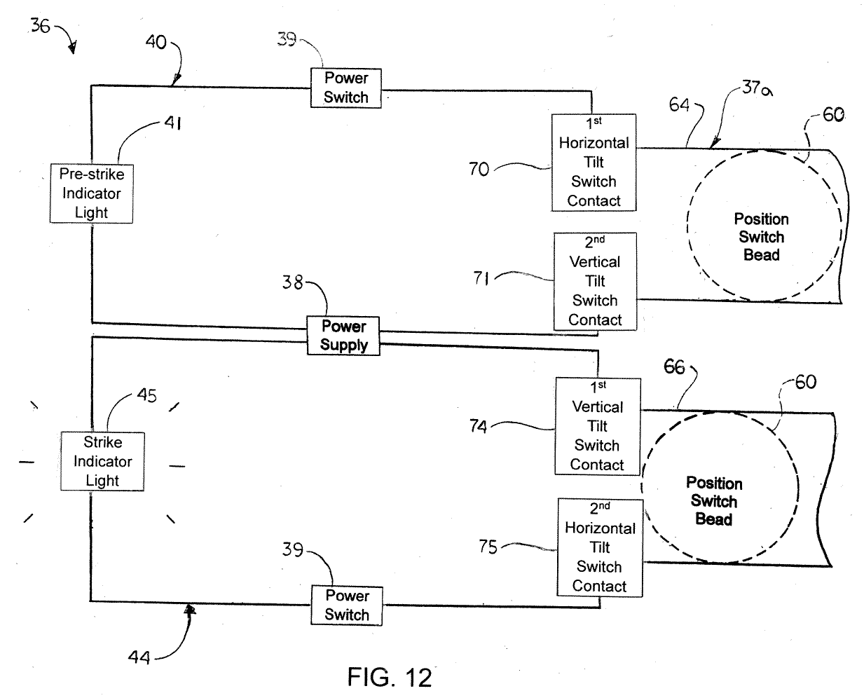

In some embodiments, the indicator illumination assembly 36 may be positioned on the main housing 2 in such a manner that the indicator illumination assembly 36 tilts within a vertical tilt plane 42 (FIG. 7) as the fish strike indicator 1 deploys from the upright horizontal position (FIG. 14) to the vertical position (FIG. 15). Accordingly, as illustrated in FIGS. 11 and 12, the horizontal position circuit 40 of the indicator illumination assembly 36 may include a horizontal tilt switch 37a. The vertical position circuit 44 of the indicator illumination assembly 36 may include a vertical tilt switch 37b. As illustrated in FIGS. 5-9, an assembly support 48 may support the horizontal tilt switch 37a and the vertical tilt switch 37b. The assembly support 48 may protrude from the interior main housing end wall 7 of the main housing 2 into the light housing interior 25 of the light housing 20, as illustrated in FIG. 5. The horizontal tilt switch 37a and the vertical tilt switch 37b may be provided in spaced-apart relationship to each other on the assembly support 48.

As illustrated in FIG. 7, the horizontal tilt switch 37a of the indicator illumination assembly 36 may have a pair of spaced-apart horizontal tilt switch contacts 70, 71. The vertical tilt switch 37b of the indicator illumination assembly 36 may have a pair of spaced-apart vertical tilt switch contacts 74, 75. A switch bead conduit 50 may be disposed in communication with the horizontal tilt switch contacts 70, 71 of the horizontal tilt switch 37a and with the vertical tilt switch contacts 74, 75 of the vertical tilt switch 37b. The switch bead conduit 50 may be disposed within the vertical tilt plane 42 of the fish strike indicator 1.

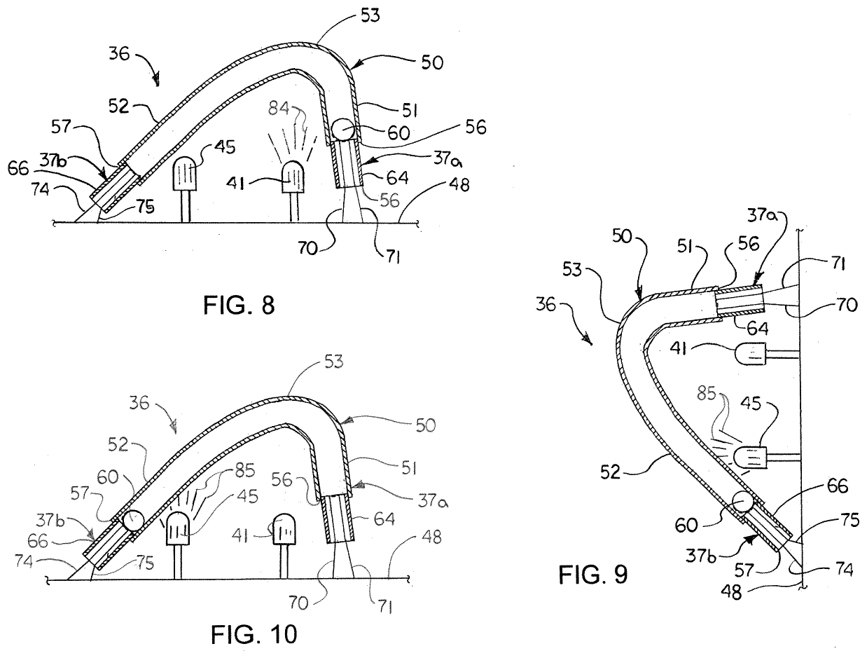

At least one electrically conductive position switch bead 60 may be disposed in the switch bead conduit 50. The position switch bead 60 may be configured to traverse the length of the switch bead conduit 50 as the fish strike indicator 1 deploys from the upright horizontal position to the vertical position on the water body 80. Accordingly, as illustrated in FIG. 8, the switch bead conduit 50 may be configured to direct the position switch bead 60 into contact with the horizontal tilt switch contacts 70, 71 of the horizontal tilt switch 37a in the upright horizontal position of the indicator (FIG. 14) to close the horizontal position circuit 40 and energize the pre-strike indicator light 41. Conversely, as illustrated in FIG. 9, the switch bead conduit 50 may be configured to redirect the position switch bead 60 from contact with the horizontal tilt switch contacts 70, 71 and into contact with the vertical tilt switch contacts 74, 75 of the vertical tilt switch 37b in the vertical position of the fish strike indicator 1, as illustrated in FIG. 15, responsive to the vertical positioning event in which the fish strike indicator 1 deploys from the upright horizontal position to the vertical position. The position switch bead 60 may thus open the horizontal position circuit 40 and then close the vertical position circuit 44 to energize the strike indicator light 45. The switch bead conduit 50 may further be configured to maintain the position switch bead 60 in contact with the vertical tilt switch contacts 74, 75 of the vertical tilt switch 37b to maintain the vertical position circuit 44 in the closed position and energizing of the strike indicator light 45 upon return deployment of the fish strike indicator 1 from the vertical position back to the upright horizontal position after the vertical positioning event, as illustrated in FIG. 16.

As illustrated in FIG. 7, the horizontal tilt switch 37a of the indicator illumination assembly 36 may have a horizontal tilt switch housing 64 at a horizontal switch end 56 of the switch bead conduit 50. The horizontal tilt switch contacts 70, 71 may be disposed in parallel, spaced-apart relationship to each other in the horizontal tilt switch housing 64. The vertical tilt switch 37b of the indicator illumination assembly 36 may have a vertical tilt switch housing 66 at a vertical switch end 57 of the switch bead conduit 50. The vertical tilt switch contacts 74, 75 may be disposed in parallel, spaced-apart relationship to each other in the vertical tilt switch housing 66.

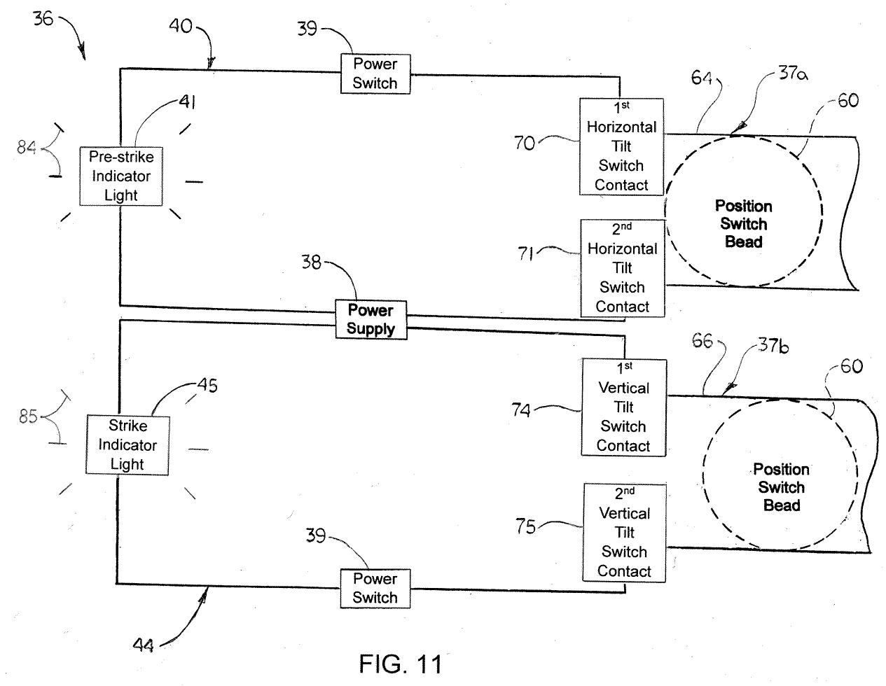

As further illustrated in FIGS. 7-10, in some embodiments, the switch bead conduit 50 of the indicator illumination assembly 36 may include a vertical conduit portion 51 disposed in communication with the horizontal tilt switch contacts 70, 71 of the horizontal tilt switch 37a. The vertical conduit portion 51 may extend upwardly from the horizontal tilt switch 37a. A conduit bend 53 may arc from the vertical conduit portion 51. A sloped conduit portion 52 may angle downwardly from the conduit bend 53. The sloped conduit portion 52 may be disposed in communication with the vertical tilt switch contacts 74, 75 of the vertical tilt switch 37b. Accordingly, the vertical conduit portion 51 of the switch bead conduit 50 may be configured to direct the position switch bead 60 into contact with the horizontal tilt switch contacts 70, 71 of the horizontal tilt switch 37a, as illustrated in FIG. 7, in the upright horizontal position (FIG. 14) of the fish strike indicator 1. The conduit bend 53 and the sloped conduit portion 52, respectively, of the switch bead conduit 50 may be configured to redirect the position switch bead 60 from contact with the horizontal tilt switch contacts 70, 71 of the horizontal tilt switch 37a into contact with the vertical tilt switch contacts 74, 75 of the vertical tilt switch 37b responsive to the vertical positioning event in which the fish strike indicator 1 deploys from the upright horizontal position to the vertical position (FIG. 15). The sloped conduit portion 52 of the switch bead conduit 50 may be configured to maintain the position switch bead 60 in contact with the vertical tilt switch contacts 74, 75 of the vertical tilt switch 37b to keep the vertical position circuit 44 closed for continued energizing of the strike indicator light 45 upon return deployment of the fish strike indicator 1 from the vertical position back to the upright horizontal position (FIG. 16) after the vertical positioning event, as illustrated in FIG. 10.

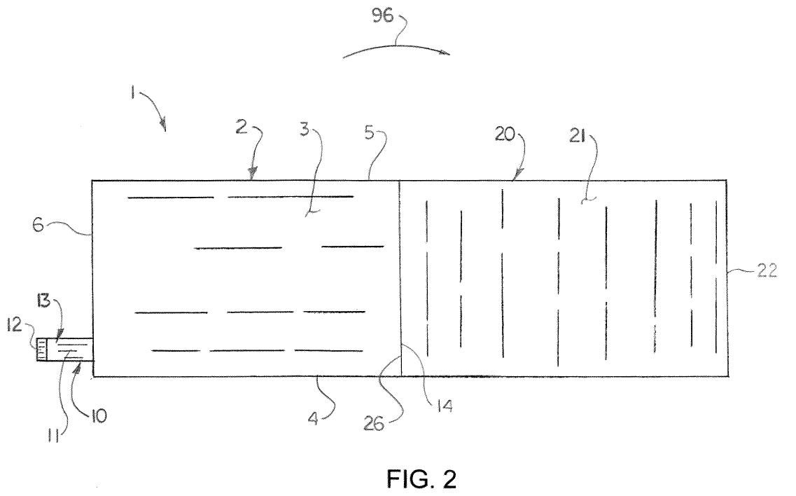

In typical application of the fish strike indicator 1, the light housing 20 may initially be detached from the main housing 2 to render accessible the indicator illumination assembly 36. In some embodiments, this may be accomplished by unthreading the housing shoulder threads 28 on the light housing sidewall 21 of the light housing 20 from the companion nipple threads 17 on the housing nipple 16 of the main housing 2, as illustrated in FIG. 6. The power switch 39 (FIGS. 11 and 12) may be manipulated from the “OFF” position to the “ON” position to energize the horizontal position circuit 40 having the pre-strike indicator light 41 and the vertical position circuit 44 having the strike indicator light 45. The light housing 20 may then be replaced on the main housing 2. The fish strike indicator 1 may be rotated to the right or in the clockwise direction of the horizontal position, as indicated by the arrow 96 illustrated in FIG. 2, to ensure that the switch bead conduit 50 directs the position switch bead 60 into contact with the horizontal tilt switch contacts 70, 71 of the horizontal tilt switch 37a, as illustrated in FIG. 8, to close the horizontal position circuit 40 and energize the pre-strike indicator light 41. The pre-strike indicator light 41 may thus emit the pre-strike light pattern 84 typically through the light housing 20 of the fish strike indicator 1.

The user of the fish strike indicator 1 may carry the fish strike indicator 1 to a selected location on the water body 80 by boat, for example. As illustrated in FIGS. 14-16, the fishing line 81 may be unwound from the line attachment cleat 10. The fishing lure 76 may be tied on the end of the fishing line 81. The unwound fishing line 81 with the fishing lure 76 thereon may be dropped and submerged beneath the surface of the water body 80 and the fish strike indicator 1 placed on the surface of the water body 80. As the fish strike indicator 1 continues to emit the pre-strike light pattern 84, the user may leave the fish strike indicator 1 at the selected location on the surface of the water body 80. As the remote user continues to periodically observe the fish strike indicator 1 from a distance, continued emission of the pre-strike light pattern 84 from the fish strike indicator 1 may indicate that the fish 94 has not become hooked on the fishing line 81.

In the event that the fish 94 subsequently strikes the fishing lure 76 and becomes hooked on the fishing line 81, the fish 94 may exert the downward force 78 on the fishing line 81, as illustrated in FIG. 15. Accordingly, the fish strike indicator 1 may deploy from the upright horizontal position illustrated in FIG. 14 to the vertical position illustrated in FIG. 15. This vertical positioning event may cause the position switch bead 60 to travel from the horizontal tilt switch 37a through the vertical conduit portion 51, the conduit bend 53 and the sloped conduit portion 52, respectively, of the switch bead conduit 50, and into contact with the vertical tilt switch contacts 74, 75 of the vertical tilt switch 37b, as illustrated in FIG. 9. The switch bead 60 may thus open the horizontal position circuit 40 and close the vertical position circuit 44 of the indicator illumination assembly 36 to extinguish the pre-strike indicator light 41 and energize the strike indicator light 45, respectively. The strike indicator light 45 may thus emit the strike light pattern 85 typically through the light housing 20 of the fish strike indicator 1. The strike light pattern 85 may indicate to the remote user that the fish 94 has become hooked on the fishing line 81 such that the user can then approach and retrieve the fish strike indicator 1 for removal of the fish 94 from the fishing lure 76. As illustrated in FIG. 10, it will be appreciated by those skilled in the art that, due to the configuration of the sloped conduit portion 52 of the switch bead conduit 50, the position switch bead 60 may remain in contact with the vertical tilt switch contacts 74, 75 of the vertical tilt switch 37b and keep the vertical position circuit 45 closed to continue to energize the strike indicator light 45 after the fish strike indicator 1 subsequently returns to the upright horizontal position on the water body 80, as illustrated in FIG. 16.

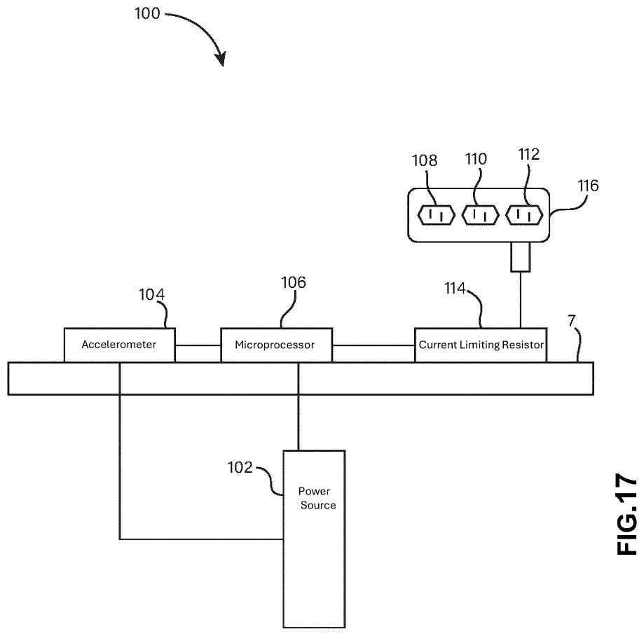

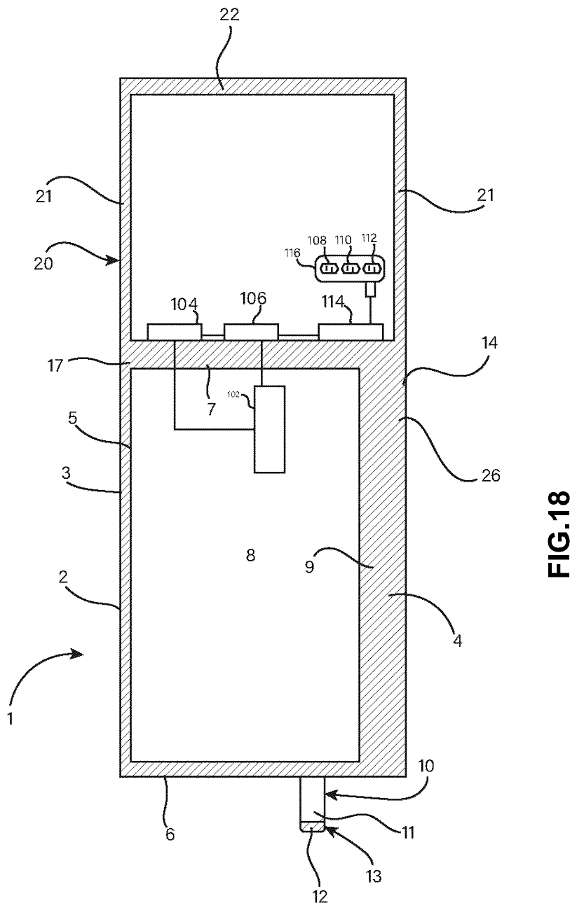

Referring now to FIG. 17 and FIG. 18, what is depicted is another exemplary embodiment of an indicator illumination assembly 100 useful with the present invention. The present invention includes an indicator illumination assembly 100 having a power source 102, an accelerometer 104, a microprocessor 106, a current limiting resistor system 114, and an RGB LED system 116. Indicator illumination assembly 100 includes a power source 102 for supplying electrical power for the operation of indicator illumination assembly 100. Power source 102 may interface with accelerometer 104. Power source 102 may further interface with microprocessor 106. Power source 102 may interface with current limiting resister 114, which may further interface with a RGB LED system 116. RGB LED system 116 may include any component or system configured to emit visible light. LED dies. For example, RGB LED system 116 may include a conventional RGB LED having a red LED die 108, a green LED die, and a blue LED die 112. In one exemplary embodiment, RGB LED system 116 may be supported by interior main housing end wall 7.

Power source 102 may be of similar description and operation as power source 38 described above. Power source 102 may be configured to provide power to the various elements of indicator illumination assembly 100. In one exemplary embodiment, power source 102 may consist of a battery pack having one or more conventional batteries. Power source 102 battery pack may be a 3-volt battery pack consisting of, for example, conventional 2 AAA size batteries.

Accelerometer 104 can be any conventional device used to measure the vibration and acceleration of the motion of a structure. A typical accelerometer suitable for this invention may measure the motion along the structure's geometric axis to provide the structure's position data. For example, an accelerometer that may be useful with this invention may be a 2-axis accelerometer or a 3-axis accelerometer. To facilitate understanding of the invention, accelerometer 104 may be configured to measure the acceleration forces on fish strike indicator 1 and provide the related fish strike indicator 1 geometric position data. Accelerometer 104 may measure the acceleration forces along fish strike indicator 1 axis and generate fish strike indicator 1 position data for providing to microprocessor 106. Accelerometer 104 may transmit the position data to microprocessor 106. Microprocessor 106 may interpret the position data and issue commands to the RGB LED system 116.

Microprocessor 106 may be any conventional microprocessor configured to receive fish strike indicator 1 position data and calculate operation commands for providing to RGB LED system 116. A typical microprocessor 106 useful in the present invention may be, for example, an 8-Bit microprocessor central processing unit. In one exemplary embodiment, instructions for operating RGB LED system 116 may be stored in microprocessor 106 memory. During operation, microprocessor 106 may receive the fish strike indicator 1 position data and fetch the instructions from microprocessor 106 memory and decode the fish strike indicator 1 position data to determine the commands necessary to operation of RGB LED system 116.

Upon receiving the position data, microprocessor 106 executes a series of pre-stored instructions in its memory to determine the commands to send to RGB LED system 116. In one exemplary embodiment, microprocessor 106 uses an internal clock to synchronize its operations, ensuring that the commands are provided to RGB LED system 116 in real-time. Once microprocessor 106 determines which commands to send, the commands are sent to the current limiting resistor system 114. Current limiting resistor system 114 receives the commands and modulates the current flow to each LED die in the RGB LED system 116. RGB LED system 116 receives the commands from current limiting resistor system 114 and provides one or more currents to RGB LED system 116 to activate the LED dies. Namely, current limiting resistor 114 receives the commands from microprocessor 106 and uses them to provide varying currents to red LED die 108, green LED die 110, and blue LED die 112 to emit light or to not emit light. In one embodiment, each LED die RGB LED system 116 may receive the currents and cause red LED die 108, green LED die 110, and blue LED die 112 to emit a range of colors, including red, green, blue, yellow, aqua, purple, or white, allowing the user to visually monitor the strike indicator. As discussed more fully below, the user has the option to select specific colors as desired, providing flexibility in visual feedback during fishing activities. A typical RGB LED system that may be used with this invention includes, for example, those found in 5050 RGB LED packages.

Current limiting resistor system 114 may be a conventional current limiting resistor combination of resistors, or other current limiting components as is found in the art. Although described herein as a separate element, it is understood that devices configured to limit current flow are considered within the definition of current limiting resistor system 114.

Current limiting resistor system 114 may receive the commands from microprocessor 106 and use the commands to control the amount of current flowing to red LED die 108, green LED die 110 and blue LED die 112. Current limiting resistor system 114 may be responsive to the commands received and provide multiple electrical currents for controlling the color of the light emitted by the RGB LED system 116.

Upon powering up, microprocessor 106 initiates a configuration process to ready the visual fish strike indicator 1 for operation. During this initial phase, microprocessor 106 configures all the microprocessor 106 input/output (I/O) lines and allocates necessary peripheral resources. Microprocessor 106 then calibrates its internal oscillator to ensure precise timing for subsequent operations. Following this, microprocessor 106 sends an initialization sequence to the accelerometer 104, preparing microprocessor 106 for accelerometer 104 to measure and relay position data accurately. To ensure fish strike indicator 1 is in a Ready State, microprocessor 106 sends a command to current limiting resistor system 114 to eliminate the current provided each LED die within the RGB LED system 116, ensuring no unintended illumination occurs during setup. Microprocessor 106 powers off each LED die by providing instructions to the current limiting resistor system 114 to provide limited current, or no current, to red LED die 108, green LED die 110 and the blue LED die 112. As used herein, limiting the current may mean that the value of the current provided to the red LED die 108, green LED die 110 and the blue LED die 112 may be insufficient to cause one or more of the LED dies to emit light.

Once the operation of the fish strike indicator 1 is initiated, for example by shaking, microprocessor 106 may cause a delay in operation to allow the system to stabilize before advancing to the next operational stage. In one exemplary embodiment, the delay may be 500 milliseconds to allow the fish strike indicator 1 to stabilize. This brief delay ensures that all components are fully initialized and synchronized and any transient signals that might affect performance are eliminated.

Following the delay, the accelerometer 104 may begin collecting motion data of fish strike indicator 1 by sampling the fish strike indicator motion 1 data at a predetermined sample rate. For example, accelerometer 104 may collect 20 motion samples of fish strike indicator 1 motion at a sample cycle rate of 28 Hz. In one embodiment, accelerometer 104 may provide a precise reading of the fish strike indicator 1 position along the fish strike indicator 1 axis. Accelerometer 104 may buffer these samples before sending the position data to microprocessor 106 for processing. This approach balances responsiveness and data accuracy, enabling the fish strike indicator 1 to detect and respond to movement while conserving processing resources.

Fish strike indicator 1 may initiate a Self-Test sequence to determine if elements of the invention are operating as intended. The Self-Test sequence may begin by individually activating each of the LED dies in the RGB LED system 116. Microprocessor 106 may provide instructions to the current limiting resistor system 114 to provide current for illuminating each of the red LED die 108, the green LED die 110, and the blue LED die 112. For example, microprocessor 106 may provide instructions or commands to the current limiting resistor system 114 to test each LED sequentially or variously providing current to each of the RGB LED system 116 LED dies for 400 milliseconds sequentially. If each LED emits light, then the test is successful. This step provides visual confirmation that each LED die in the RGB LED system 116 is responsive and capable of emitting light. Once all LED dies have been tested, microprocessor 106 sends a command to the current limiting resistor system 114 to turn off all LED dies (e.g., eliminate the current to each LED).

After completion of the Self-Test sequence described above, accelerometer 104 may detect fish strike indicator 1 motion data to determine fish strike indicator 1 orientation. By way of example, the Self-Test may be considered successful if microprocessor 106 receives position data from the accelerometer 104 indicating that the z-axis reading is greater than a predetermined offset and the x-axis and y-axis are within a narrow range one to the other. A typical successful Self-Test may occur if accelerometer 104 returns a z-axis reading greater than 60/64 g, and an x-axis and y-axis readings are the narrow range of −3/64 g to +3/64 g.

Once microprocessor 106 completes the Self-Test sequence described above, microprocessor 106 may then send a command to the current limiting resistor to activate one of the RGB LED system 116 LEDS to visually indicate that the fish strike indicator 1 is in proper operation and all LED may emit light upon command from microprocessor 106. For example, microprocessor 106 may send a command to current limiting resistor system 114 to instruct current limiting resistor system 114 to provide current to activate the green LED die 110 to emit light. By activating the green LED die 110, the user is provided with a visual confirmation that fish strike indicator 1 has successfully passed the Self-Test and is ready to detect fish strikes.

This Self-Test sequence ensures fish strike indicator 1 is accurately calibrated, red LED die 108, blue LED 110, and green LED die 112 are functional, and that accelerometer 104 is correctly positioned to detect movement of fish strike indicator 1 during use.

Fish strike indicator 1 may enter a Sleep State (e.g., fish strike indicator 1 is turned off). Fish strike indicator 1 may enter into a Sleep State when the user holds the fih strike indicator with the light housing 20 in a down position (e.g., held with the main housing 20 above light housing 20) for a predetermined period. For example, fish strike indicator 1 enters into the Sleep State when the user holds the main housing 2 above the light housing for a period of 2.5 seconds. Accelerometer 104 indicates that fish strike indicator 1 has entered Sleep State and sends fish indicator data to microprocessor 106 indicating that the light housing 20 is being held below the main housing 2 for 2.5 seconds. Microprocessor 106 then sends a command to current limiting resistor system 114 limit or eliminate the current to the RGB LED system 116 LED dies. This in turn, ensures that all LED dies are turned off. This conserves the battery life of power source 102 by minimizing power usage during the Sleep State.

While in the Sleep State, microprocessor 106 remains dormant until microprocessor 106 receives an interrupt signal from accelerometer 104. Accelerometer 104 may generate an interrupt signal by sampling fish strike indicator 1 position for a predetermined period. Microprocessor 106 may generate position data once every 714 milliseconds. Sampling for interrupt signal may continue until accelerometer 104 has stored 20 samples. Once accelerometer 104 has sampled 20 samples, accelerometer 104 may provide an interrupt signal to microprocessor 106. Upon receiving the interrupt signal, microprocessor 106 may briefly resume operation to retrieve and examine interrupt signal to determine if a wake-up motion has been detected. If a wake-up motion is detected, fish strike indicator 1 is placed in Battery Test State

If, however, accelerometer 104 does not send an interrupt signal including a wake-up sequence microprocessor 106 may determine that no valid wake-up motion has occurred. In this case, microprocessor 106 may return fish strike indicator 1 to a Sleep State and may awaiting the next interrupt signal from the accelerometer 104. This approach conserves energy while ensuring the fish strike indicator 1 remains responsive to the wake-up motion.

In the instances where microprocessor 106 places fish strike indicator 1 in Battery Test State, microprocessor 106 may initiate a check to determine if the power source 102 voltage is below a predetermined value for fish strike indicator 1 operation. Microprocessor 104 may receive a voltage value from power source 102 and compare the received voltage value to the predetermined value. If the received voltage value is below the predetermined voltage value, then microprocessor 106 may cease operation.

In a Low Battery State, (e.g., the voltage value is below the predetermined value) microprocessor 106 may send a command to the current limiting resistor system 114 to provide a current to RGB LED system 116 to visually signal the user that power source 102 is in a low power condition. Microprocessor 104 may provide a command to current limiting system 114 to provide a current to red LED die 108 to cause the red LED die 108 to flash one or more times at a rate for indicating a low voltage battery value. When power source 102 is in Low Battery State, microprocessor 106 may return fish strike indicator 1 to the Sleep State, conserving any remaining battery life.

On the other hand, if the microprocessor 106 receives a battery voltage value from the power source 102 that is above the predetermined voltage value (e.g., Good Battery State) then the power source 102 has sufficient power to operate the fish strike indicator 1 to detect fish. For example, if the power source value received by microprocessor 106 is evaluated to be equal to or exceeding predetermined value, microprocessor 106 transitions the fish strike indicator 1 into a Good Battery State.

When the device enters the Good Battery State, power source 102 has sufficient charge for operation of the fish strike indicator 1 to enable the fish strike indicator 1 to detect that a fish 94 is connected to the fishing line 81. In Good Battery State, green LED die 110 may flash at a rate for indicating that the power source has sufficient power to operate fish strike indicator 1. This flashing pattern signals to the user that fish strike indicator 1 is prepared to detect fish.

Following this visual confirmation, accelerometer 104 may increase its sample rate to enhance fish strike indicator 1 sensitivity to movement. Fish strike indicator 1 may then enter a Waiting to Fish State, where fish strike indicator 1 may be ready to detect activity associated with fishing.

At any point during operation of the fish strike indicator 1, the user may cancel the current state and return the fish strike indicator 1 to the Sleep State by placing the fish strike indicator 1 in an off position. The user may place fish strike indicator 1 in an off position by pointing light housing 20 in a down position below main housing 2. Accelerometer 106 detects that fish strike indicator 1 has been placed in the off position when the accelerometer reads fish strike indicator 1 data indicating the light housing 20 is positioned below main housing 2 for a predetermined period. For example, accelerometer 104 for a continuous duration of 250 samples, equivalent to 2.5 seconds. Upon detecting this orientation, accelerometer 104 sends position data to microprocessor 106, which in turn, provides accelerometer 104 a signal to lower accelerometer 104 sampling rate back to 28 Hz. In this instance, lowering the sampling rate may return the fish strike indicator 1 to the Sleep State. As previously noted, the battery life of power source 102 is preserved until the fish strike indicator 1 is placed in a power up state.

In the Waiting to Fish State, the fish strike indicator 1 may signal its readiness to detect a fish strike by flashing one or more of the RGB LED system 116 LED dies in a color selected by the user. In one instance, microprocessor 106 may provide a command to the current limiting resistor 114 to flash the selected LED color at a predetermined waiting to fish rate or pattern.

As previously noted, the user may select a desired, or alternate, LED color for RGB LED system 116 to emit. Green LED die 112 emitting green light is the default color emitted, which is seen, for example, after the user recharges or replaces power source 102 (e.g., changes the batteries). RGB LED system 116 may emit a green light from green LED die 112, such as when the microprocessor 106 sends a command to the current limiting resistor system 114 to provide a current to the green LED die 112. During the Waiting for Fish Strike State 30-second window discussed above, the user has the option to change the color being emitted though the light housing 20. In one example, the user may change the color being emitted by rotating fish strike indicator 1 horizontally. The user may rotate fish strike indicator 1 horizontally by manually grasping main housing 2 and moving the light housing 20 in a circular motion about a fish strike indicator 1 axis for a predetermined number of rotations. For example, each time the user completes at least three full revolutions of the light housing 20 in the horizontal position, the microprocessor 106 may send a command to current limiting resistor system 114 to provide multiple currents to RGB LED system 116 to selectively charge one or more of the red LED die 108, green LED die 110, or blue LED die 112 to emit one or more individual colors. In this instance, the color emitted from the light housing 20 will change. Any additional complete rotation will continue cycling through the available color options. The color emitted from the light housing 20 may change to the next light emitting sequence according to the rotations. As noted above, exemplary colors available to the user to select from may be green, blue, red, yellow, aqua, purple or white, or any color as provided by a convention RGB LED system.

The user may continue to change colors emitted by rotating the light housing 20 as described above until a period for selecting a desired color has expired. For example, the user may rotate light housing 20 for a period of 30 seconds, Once the 30-second period has expired, the desired color is deemed to be selected and the color emitted from light housing 20 becomes fixed. At this point, fish strike indicator 1 enters a Ready to Fish State. In the Ready to Fish State the color remains fixed on the color the user selected. This sequence provides an easy-to-use method for users to customize the LED color, enhancing visibility and preference during fishing without compromising on power or functionality.

In the Ready to Fish State, RGB LED system 116 LED dies may flash in the selected color at a select frequency for a selected duration (e.g., selection period). For example, RGB system 116 LED dies may flash at 6.25 Hz-approximately six flashes per second—for a duration of 10 seconds. Microprocessor 106 may detect the Ready to Fish State when the time period for selecting a new color has expired. This ensures a stable transition of the fish strike indicator 1 into the Waiting for Bite State without any false triggers.

In one example of the invention, once the selection period concludes, microprocessor 106 advances indicator illumination assembly 100 to Waiting for Bite State. In the Waiting for Bite state, the LED dies emitting the desired color may remain continually illuminated in the user-selected color, providing a constant visual signal to the angler when fish strike indicator 1 is floating on the water.

In the Waiting to Bite State, accelerometer 104 actively detects the fish strike indicator 1 motion data. Specifically, the accelerometer 104 monitors fish strike indicator 1 motion to detect a downward pull, or multiple downward pulls in quick succession and generates fish strike data-a telltale sign of a fish strike. For example, accelerometer 104 may detect a fish strike by detecting successive downward pulls within 50 milliseconds. When the fish strike is detected, accelerometer 104 may provide the fish strike data to microprocessor 106, which receives the fish strike data and places the fish strike indicator 1 in a Fish on State.

In the Fish on State, fish strike indicator 1 enters a fish strike alert mode. In the fish strike alert mode, microprocessor 106 sends a command to RGB LED system 116 to emit a flashing sequence having multiple colors and varying speeds (the fish strike pattern) indicating that a fish 94 is on the line. This visual fish strike pattern ensures that the angler can quickly identify the activity, even from a distance.

Once accelerometer 104 detects a fish strike motion, accelerometer 104 provides the fish strike motion data to microprocessor 106. Microprocessor 106 receives the fish strike motion data and disregards all data received from accelerometer 104 except where accelerometer 104 sends position data which place fish strike indicator 1 in Sleep State. This action of disregarding data received from microprocessor 106 prevents accidental resets or changes. Flashing in a fish strike pattern serves as an indication that a fish 94 is on line 81, providing the angler with a real-time visual cue to reel in the catch.

While the preferred embodiments of the invention have been described above, it will be recognized and understood that various modifications may be made in the invention that are within the spirit scope of the claims and the appended claims are intended to cover all such modifications which may fall within the spirit and scope of the invention. For example, the components and operation of a conventional accelerometer, microprocessor, current limiting resistor may not be discussed here, for brevity. Such elements and operation of the conventional components discussed herein are well understood by one skilled in the art and are considered to be within the description of this invention. Further still, it is understood that elements of the invention may be combined into fewer elements to reach the operability of indicator illumination assembly 100, or fish strike indicator 1.

We claim:

1. A visible fish strike indicator, comprising:
a buoyant main housing having a horizontal center axis and a center of gravity beneath the horizontal center axis, whereby the main housing is configured to normally float in an upright horizontal position on a water body;
a light-transmissible light housing having a light housing interior detachably supported by the main housing;
an indicator illumination assembly supported by the main housing, the indicator illumination assembly including:
a power source for proving electrical power to the indicator illumination assembly;
an accelerometer interfacing with the power source and receiving the electrical power from the power source, the accelerometer for sensing specific directions and patterns of movement of the visual fish strike indicator, and generating fish strike indicator position data,
a microprocessor interfacing with the accelerometer and the power source, the microprocessor for receiving the fish strike indicator position data and generating operation command data based on the specific directions and patterns of movement of the visual fish strike indicator,
a current limiting resistor system interfacing with the microprocessor, the current limiting resistor system configured to receive the operation command data from the microprocessor and provide an electrical current;
an RGB LED system interfacing with the current limiting resistor system, the RGB LED system for receiving the electrical current and emitting a visible light.

2. The visible fish strike indicator of claim 1, wherein the light housing threadably engages the main housing.

3. The visible fish strike indicator of claim 1, further comprising a line attachment cleat extending from the main housing.

4. The visible fish strike indicator of claim 3, wherein the line attachment cleat is disposed beneath the horizontal center axis of the main housing.

5. The visible fish strike indicator of claim 1, wherein the accelerometer is configured to detect an initialization sequence and generate an initialization data, wherein the microprocessor is configured to receive the initialization data and send an operation command to the current limiting resistor provide current provided to the RGB LED system.

6. The visible fish strike indicator of claim 5, wherein the microprocessor is configured to receive the initialization data and send a command to the accelerometer to begin a Self-Test sequence.

7. A visual fish strike indicator of claim 1, wherein the microprocessor is configured to receive a voltage value from the power source and compare the power source voltage value to a predetermined voltage value.

8. A visual fish strike indicator of claim 7, wherein the microprocessor places the fish strike indicator in Sleep Mode when the microprocessor determines that power source voltage value is less than the predetermined voltage value.

9. A visual fish strike indicator of claim 7, wherein the microprocessor sends a command data to the current limiting resistor to provide the electrical current to the RGB LED system to emit light when the microprocessor determines that the power source voltage level is greater than the predetermined voltage value.

10. A visual fish strike indicator of claim 6, wherein the accelerometer senses fish strike data, and provides the fish strike data to the microprocessor, wherein the microprocessor receives the fish strike data and provides a fish strike command data to the current limiting resistor, wherein the current limiting resistor receives the fish strike data and provides multiple currents to the RGB LED system for causing the RGB LED system to emit in multiple color and varying speeds.

11. A visual fish strike indicator of claim 1, wherein fish strike indicator data includes a Sleep State pattern, wherein the microprocessor receives the fish strike indicator data and transitions the visual fish strike indicator in a Sleep State.

12. A visual fish strike indicator of claim 1, wherein the fish strike indicator data includes a wake-up pattern, wherein the microprocessor receives the wake-up pattern and activates the visual fish strike indicator.

13. A visual fish strike indicator of claim 1, wherein the fish strike indicator data includes a color change pattern, wherein the microprocessor receives the fish strike indicator data including the color change pattern and provides the operation command data to the current limiting resistor, wherein the current limiting resistor receives the operation command and provides current to the RGB LED system to change the color of the visible light emitted in the light housing.
